(19) United States
(12) Patent Application Publication
(10) Pub. No.: US 2006/0266767 A1
(43) Pub. Date: Nov. 30, 2006

(54) Water cooler adapter

(76) Inventor: Randy Butters, Salt Lake City, UT (US)

Correspondence Address: THORPE NORTH & WESTERN, LLP., 8180 SOUTH 700 EAST, SUITE 200, SANDY, UT, 84070, US

(21) Appl. No.: 11/417,013

(22) Filed: May 2, 2006

Related U.S. Application Data
(60) Provisional application No. 60/594,726, filed on May 2, 2005.

(51) Int. Cl. B67D 5/08; F04F 10/00

(52) U.S. Cl. 222/67; 222/64; 222/416

(57) ABSTRACT

An adapter for converting a bottled water dispenser to receive an upright liquid container is disclosed. The adapter includes a cover, a siphon assembly, and a valve. The cover covers a top opening of the bottled water dispenser and supports the upright liquid container. The siphon assembly has a suction portion for insertion into the upright liquid container and an output portion for discharging liquid into the top opening of the liquid container. The valve extends into the top opening of the bottled water dispenser and regulates liquid discharge from the output portion based on a liquid level within a reservoir chamber of the bottled water dispenser.

This application claims the benefit of United States Provisional Patent Application Serial No. 60/594,726 filed on May 2, 2005, entitled “Water Cooler Adapter” which is incorporated herein by reference.

### FIELD OF THE INVENTION

The present invention relates generally to liquid dispensers. More particularly, the present invention relates to an adapter for converting a liquid dispenser to receive an upright liquid container.

### BACKGROUND

Various types of bottled water dispensers are known. One common type is a gravity fed system, where the bottle is inverted to place the neck of the bottle into an opening at the top of the dispenser. The dispenser includes a reservoir, but the reservoir often has insufficient capacity to hold the entire contents of the bottle. A well-known pressure differential effect provides regulation of flow from the inverted bottle into the reservoir. The neck of the bottled extends into the reservoir, so that when the level of the water within the reservoir reaches the neck of the bottle, there is no path for entry of air into the bottle. Further discharge of water from the bottle creates a partial vacuum within the bottle, slowing and stopping flow from the bottle. As the water level drops within the reservoir, the neck is eventually exposed, allowing air to bubble into the bottle, releasing the vacuum, and allowing water to flow into the reservoir.

The above-described dispensing system has a number of undesirable aspects. Placing the neck of the bottle into the opening at the top of the dispenser can result in dust or other contaminants from the neck of the bottle to be introduced into the reservoir. Typically, bottled water is provided in five-gallon containers that weigh approximately 45 pounds when full. The bottle must be inverted and placed into the open top of the dispenser quickly, as the contents of the bottle begin to run out as soon as the bottle is inverted. Inverting the bottle for insertion into the dispenser is thus awkward and prone to spillage. Occasionally, bottles develop small cracks or leaks. Small cracks or leaks, too small to allow appreciable water leakage when the bottle is upright, can allow air into the inverted bottle. This air leakage releases the partial vacuum, allowing free flow of water out of the bottle which can overflow the reservoir.

Attempts to avoid these problems have included systems that provide for placement of the bottle next to the dispenser or inside the bottom of the dispenser. Such systems typically include a pump to move water from the container up and into the reservoir. Manually pumping water can be tedious, but electronic pumps and regulators can be less reliable than passive gravity fed systems.

### SUMMARY OF THE INVENTION

Briefly, and in general terms, one embodiment of the invention is an adapter for converting a bottled water dispenser to receive an upright liquid container. The adapter includes a dispenser cover to cover a top opening of the bottled water dispenser and provide a surface to support the upright liquid container when placed thereon. The adapter includes a siphon assembly having a suction portion for insertion into the upright liquid container and an output portion for discharging liquid into the top opening of the liquid container. A valve is operatively coupled to the dispenser cover and configured to extend into the top opening of the bottled water dispenser. The valve regulates liquid discharge from the output portion of the siphon assembly based on a liquid level within a reservoir chamber of the bottled water dispenser.

In another embodiment, a system for dispensing liquid from an upright container can comprise a dispenser body having a reservoir chamber disposed therein, a fluid receiving port in a top surface of the dispenser body in fluid communication with the reservoir chamber, and a tap in fluid communication with the reservoir and configured to controllably dispense the liquid from the reservoir. The system can also include a cover positioned on top of the dispenser body which covers the fluid receiving port, a liquid container placed on top of the cover in an upright orientation, a means for siphoning liquid from the liquid container into the fluid receiving port, and a means for regulating flow of the siphoning means based on a liquid level within the reservoir chamber.

In another embodiment, a method for transferring liquid from an upright container into a bottled water dispenser of the type having an internal reservoir and a top opening for receiving an inverted water bottle to supply fluid to the reservoir is provided. The method can comprise covering the top opening of the bottled water dispenser with a cover assembly, placing a liquid container in an upright orientation on top of the cover assembly, and siphoning liquid from the liquid container into the reservoir via a siphon assembly. Additional steps can include interrupting liquid flow through the siphon assembly when a first predetermined liquid level is reached within the reservoir, and reestablishing liquid flow through the siphon assembly when a second predetermined liquid level is reached within the reservoir.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a side schematic view of a system for dispensing liquid from an upright container in accordance with an embodiment of the present invention;

FIG. 2 is a side schematic view of an adapter for converting a bottled water dispenser to receive an upright liquid container in accordance with an embodiment of the present invention;

FIG. 3 is a side schematic view of a cover for a bottle water dispenser adapter in accordance with an embodiment of the present invention; and

FIG. 4 is a flow chart of a method for transferring liquid from an upright container into a bottled water dispenser in accordance with an embodiment of the present invention.

### DETAILED DESCRIPTION OF EXAMPLE EMBODIMENT(S)

In describing and claiming the present invention, the singular forms “a,” “an,” and “the” include plural referents unless the context clearly dictates otherwise. Thus, for example, reference to “a seal” includes reference to one or more of such seals. It should be noted that the discussion of a particular element or structure with respect to the devices, systems, and methods of the present invention does not infer that each element or structure is necessary. Rather, more complete systems and methods are described to set forth exemplary embodiments in accordance with the present invention.

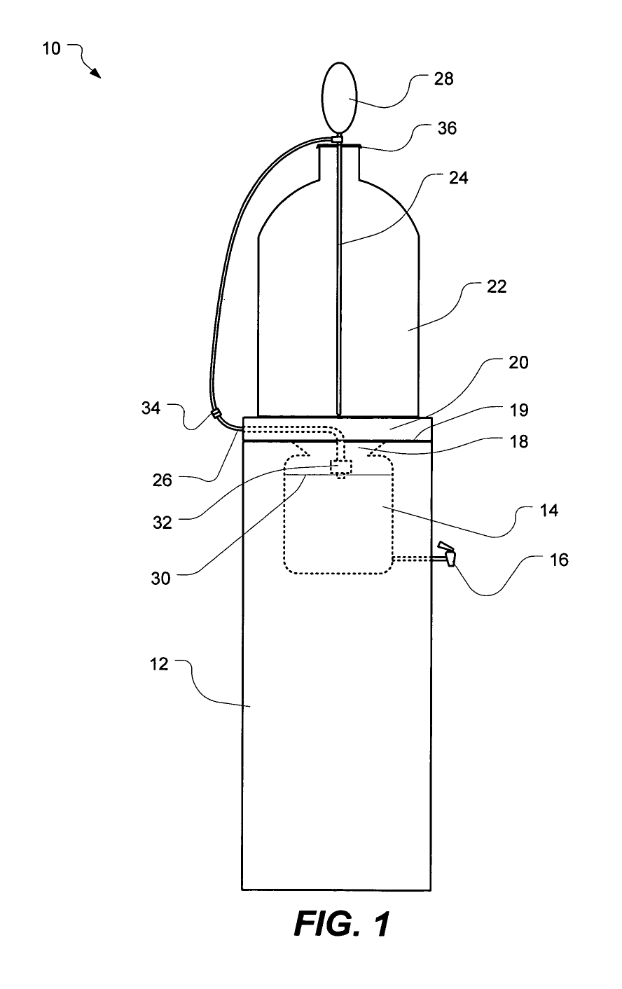

As illustrated in FIG. 1, a system for dispensing liquid from an upright container is shown generally at 10 in an exemplary embodiment of the invention. The system includes a dispenser body 12, having a reservoir chamber 14 disposed therein. Fluid within the reservoir can be controllably dispensed from a tap 16. A fluid receiving port 18 in a top surface 19 of the dispenser body is in fluid communication with the reservoir. For example, the dispenser body can be of a type which normally receives an inverted bottle positioned with the neck of the bottle inserted into the fluid receiving port.

A cover 20 is positioned on top of the dispenser body 12 and covers the fluid receiving port. A liquid container 22 is positioned on top of the cover in an upright orientation. The cover can include additional features to help keep the liquid container positioned on top of the dispenser body as discussed further below. For some dispenser types, an upper portion of the dispenser body, such as a plastic protective sleeve (not shown) surrounding the fluid receiving port, may be removed before positioning the cover on top of the dispenser body.

The system 10 includes a means for siphoning liquid from the liquid container into the fluid receiving port. For example, siphoning means can be a siphon assembly having a suction portion 24 for insertion into the upright liquid container and an output portion 26 for discharging liquid into the fluid receiving port 18 or reservoir 14.

The siphon means can include means for initiating a siphon, for example, a squeeze bulb 28 and one way valves (not shown) as known to one skilled in the art. Alternate means for initiating a siphon known in the art include piston or syringe type siphon pumps, accordion type pumps, and the like.

The system 10 includes a means for regulating flow of the siphoning means based on a liquid level 30 within the reservoir. For example, the means for regulating can be a float valve 32, as discussed further below. Because the reservoir 14 capacity may be less than the capacity of the liquid container 22, the means for regulating flow helps to avoid overfilling and overflowing of the reservoir.

Because the liquid container 22 can be positioned upright on the cover 20, inverting the liquid container is thereby avoided. This helps to reduce the possibility of spillage and injury when replacing an empty liquid container with a full container. Furthermore, regulation of flow from the container does not rely on vacuum integrity of the container. Hence, small air-leaking cracks, which can cause leakage in an inverted feed system, are less likely to cause leaks in the present system.

Another advantage of the system 10 is that flow from the liquid container 22 into the reservoir 14 is gravity fed via the siphoning means. Accordingly, in an embodiment, the system can be configured to operate without electrical power. This can provide benefits in allowing operation in situations where no electrical power is available and allow simpler, less expensive designs to be used for the regulating means.

The system 10 beneficially helps to reduce the potential for contamination of the liquid in the reservoir 14. The neck of the liquid container 22 is not placed into the reservoir, helping to reduce introduction of dust and contaminants into the liquid. Additionally, the cover 20 helps to prevent contaminants from being introduced from the exterior environment into the fluid receiving port and reservoir. Replacement of the liquid container can be performed without removal of the cover, avoiding exposing the reservoir.

Replacement of an empty liquid container can be accomplished by removing the suction portion 24 of the siphon means from the empty liquid container, replacing the empty container with a full container, reinserting the suction portion into the liquid container, and restarting the siphon. Alternately, the empty liquid container can be removed, a full container placed on top of the dispenser, and then the suction portion moved from the empty container to the full container. Other sequences of replacing an empty liquid container may also be used.

To assist in replacing the liquid container and provide easy removal of the suction portion, the siphon means can include a coupler 34 configured to allow the output portion to be separated from the input portion. For example, the coupler can be a quick connect. The coupler can also include one or more check valves to inhibit fluid flow when the suction portion is separated from the output portion.

Various check valves can be included within the siphon means to help ensure proper fluid flow through siphon. For example, a check valve can be included in the suction portion 24 to help initiate the siphon and inhibit leakage from the suction portion when removed from the liquid container 22. Placing a check valve at the bottom of the suction portion can be desirable. A check valve can be included in the output portion 26 to help avoid reverse flow from the reservoir 14 through the output portion when the coupler 34 is separated. A check valve in the output portion can also help avoid reverse flow if the suction portion is temporarily placed below the reservoir, for example when replacing the liquid container. Check valves can alternately be placed in the squeeze bulb 28, coupler 34, or float valve 32. Many different options for inclusion and positioning of check valves will occur to one skilled in the art having possession of this disclosure, and are to be considered within the scope of the present invention.

In initiating a siphon, it can be helpful to remove air from the siphoning means. Accordingly, the system 10 can also include an air bleed valve coupled to the output portion of the siphon means. For example, an air bleed valve can be included in the coupler 34. In one embodiment, the air bleed valve can be integrated into the coupler, so that a disconnection level also doubles as an air bleed valve control. Such an air bleed valve can also provide the benefit of allowing the user to remove air bubbles along the output portion 26, thereby preventing blockages that might occur in starting the siphoning of the water from the liquid container 22 to the reservoir 14.

The siphon means can include an escutcheon 36 coupled to the suction portion and configured to cover an opening at the top of the liquid container 22. The escutcheon can help to prevent contaminants from falling into the liquid container. The escutcheon can be disposed on the suction portion at a fixed position, or can be a friction fit onto the suction portion to allow adjustment of the vertical position. The escutcheon can also include a pressure relief disposed therein. The pressure relief allows air to enter the liquid container to replace liquid siphoned therefrom.

In FIG. 1, the output portion 26 of the siphon is shown as entering the cover 20 from the rear of the dispenser body 12, opposite the tap 16. This positioning is not essential, however. For example, the output portion can exit from the cover 20 at the side of the dispenser body. A side position is helpful if a coupler 34 is included, as this makes the coupler easier to access from the front of the dispenser body. Various other arrangements of the portions of the siphoning means can be used, as will occur to one skilled in the art.

The siphon means can also include decorative features to help present an attractive appearance. For example, the squeeze bulb 28 can be configured to present a crystal-like appearance, or have some other appearance that is decorative or includes appropriate branding for a particular home or office where the water cooler is placed, e.g., colors, shapes, etc.

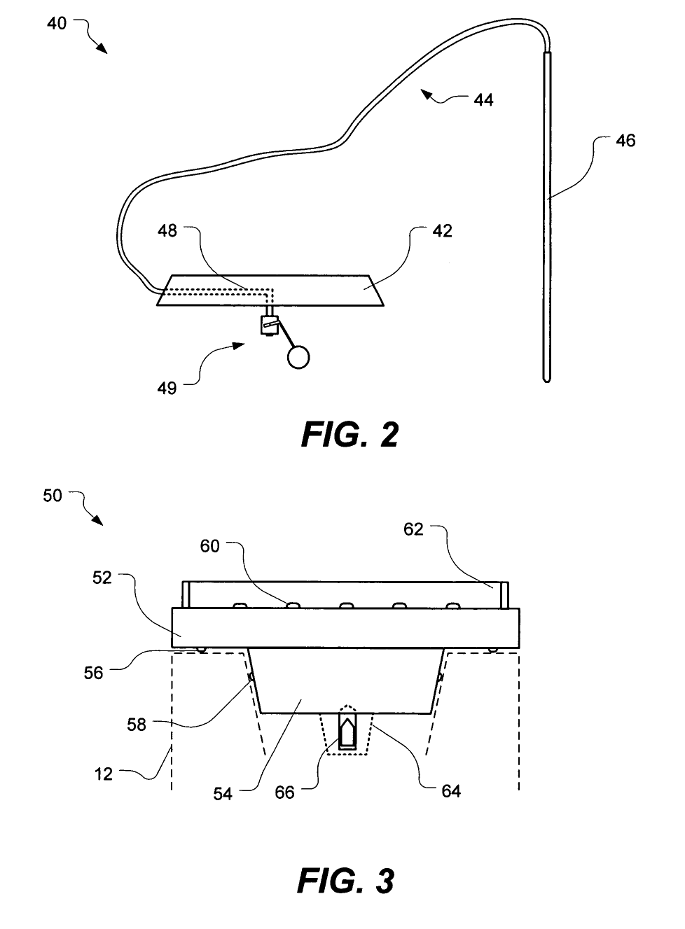

An alternate embodiment of the present invention includes an adapter for converting a bottled water dispenser to receive an upright liquid container. FIG. 2 illustrates an adapter, shown generally at 40, in accordance with another embodiment of the present invention. The adapter includes a dispenser cover 42, a siphon assembly 44, and a valve 49. The dispenser cover is configured to cover a top opening of the bottled water dispenser and provide a surface to support the upright liquid container when placed thereon.

The siphon assembly 44 has a suction portion 46 for insertion into the upright liquid container and an output portion 48 for discharging liquid into the top opening of the liquid container. For example, the suction portion can be a flexible tube slightly longer than the nominal depth of a liquid container, helping to ensure that the siphon assembly can transfer most of the liquid from the liquid container into the top opening of the liquid container. In this configuration, the flexible tube will contact the bottom and bend slightly, ensuring that the water from the bottom of the upright container can be siphoned. Alternately, the suction portion can be a semi-rigid tube having a flexible accordion-like portion disposed therein which allows the tube length to automatically adjust to different depth liquid containers. Openings can either be at the end of the tube, or can be positioned on the sides of the tube at a bottom portion thereof. Various other alternative configurations for the suction portion will occur to one of skill in the art having possession of this disclosure.

The valve 49 is in fluid communication with the output portion 48 of the siphon assembly 44 and regulates liquid discharge from the output portion based on a liquid level within a reservoir of the bottled water dispenser. For example, various electronic level detecting valves can be used. Alternately, a mechanical valve can be used, for example a lever arm float type valve as illustrated schematically here. The valve can be coupled to the dispenser cover and extend downward into the top opening when the cover is placed onto a bottled water dispenser. This allows, for example, a float portion of the valve to contact an upper liquid level limit of the reservoir to provide regulation.

In an embodiment, the valve 49 is a shutoff valve, which stops flow through the siphon assembly 44 when a predefined liquid level is reached within the reservoir. Hence, the valve can be a level sensitive valve, such as a lever arm float valve, ball and float valve, needle and seat float valve, ballcock, or the like.

FIG. 3 illustrates an alternate embodiment of a cover in accordance with an embodiment of the present invention. The cover, shown generally at 50, includes an upper portion 52 and a lower portion 54. The lower portion is configured to allow insertion into the top opening of the bottled water dispenser 12. The lower portion can function as an alignment housing to help position the cover on the dispenser. The side exterior profile of the lower portion can be configured to generally conform to the interior surface of the top opening. For example, the lower portion can be generally wedge shaped or frusto-conical in form to allow insertion into a circular top opening. Other shapes for the lower portion can be used, depending on the shape and dimensions of the top opening of the bottled water dispenser to be accommodated. A cover can be provided which includes two or more interchangeable lower portions which can be substituted to accommodate different size and shape top openings.

The cover 50 can include a first seal 56 disposed on a bottom surface of the upper portion 52 of the dispenser cover. Though shown in cross-section, the first seal is actually a ring-like structure that rests on a top surface of the dispenser 12, thereby providing isolation of the top opening of the dispenser from an exterior environment. The seal can be flexible or malleable material, such as poly, rubber, latex, and the like, helping it to conform to the top surface of the dispenser. The cover can also include a second seal 58 disposed on an outer surface of the lower portion 54. For example, the second seal (which again is shown in cross-section, but is actually a ring-like structure) can help to provide environmental isolation of the reservoir chamber from an exterior environment when the cover is placed on the bottled water dispenser. The second seal can use similar materials as the first seal, although the first seal and second seal need not be the same material. Thus, the first seal and the second seal can provide two barriers between the reservoir 14 and the external environment.

In another embodiment, the lower portion 54 of the cover 50 can be springingly coupled to the upper portion 52 to allow self-adjustment of the position of the second seal relative to the interior surface of the fluid receiving port. For example, the lower portion can telescope into the upper portion. For example, a vertical adjustment range of about one inch has proven helpful in one embodiment of the present invention.

The cover 50 can include various features to help maintain the liquid container in position atop the cover. For example, the cover can include anti-skid features 60 in the form of rubber strips or bumps disposed on a top surface of the cover. As another example, the cover can include an upwardly extending lip 62 disposed on a top surface of the dispenser cover.

The cover 50 can also include a cage 64 coupled to the cover and disposed around the valve 66 (illustrated here as a needle and seat type valve). The cage can help to avoid damage to the valve components, for example when installing or removing the cover. The cage can also help to avoid interference with the components of the valve which might cause the valve to be stuck in an open or closed position, e.g. due to incorrect positioning of the cover on top of the dispenser. The cage can be, for example, a metal screen or perforated plastic housing.

The above discussion has primarily provided examples of adapting an existing dispenser system to convert the dispenser system from accepting an inverted liquid container to operating with an upright liquid container. As will now be apparent to one of skill in the art, the principles of the present invention can also be applied in a new dispenser design. Moreover, while the above discussion has primarily concerned bottled water dispensers, the principles of the present invention can also be applied in the context of other types of liquid dispensing based on similar dispenser designs.

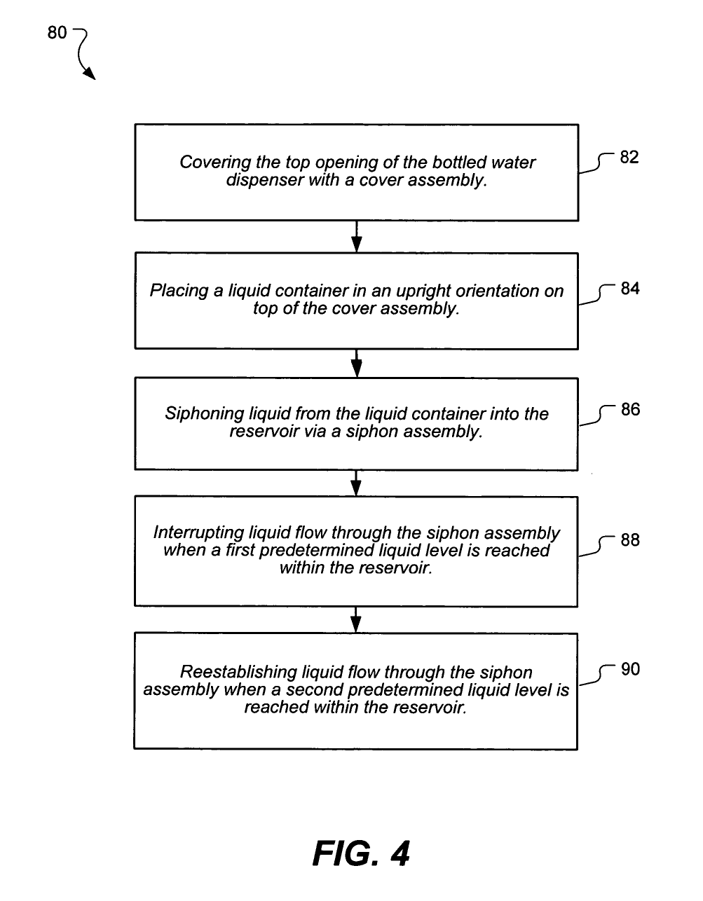

In another embodiment, a method for transferring liquid is described in flow chart form in FIG. 4 in accordance with an embodiment of the present invention. The method, shown generally at 80, enables transferring liquid from an upright container into a bottled water dispenser of the type having an internal reservoir and a top opening for receiving an inverted water bottle to supply fluid to the reservoir. The method includes the step of covering 82 the top opening of the bottled water dispenser with a cover assembly. For example, the top opening can be covered by a cover as described above. The method also includes placing 84 a liquid container in an upright orientation on top of the cover assembly, and siphoning 86 liquid from the liquid container into the reservoir via a siphon assembly. For example, various siphon assemblies are described above. Various ways for siphoning liquid are known in the art which can be applied in the context of the present invention.

The method also includes the steps of interrupting 88 liquid flow through the siphon assembly when a first predetermined liquid level is reached within the reservoir and reestablishing 90 liquid flow through the siphon assembly when a second predetermined liquid level is reached within the reservoir. For example, interrupting liquid flow and reestablishing liquid flow can be provided by a float valve, as described above. The first predetermined liquid level is an upper limit for the reservoir at which point the float valve is closed. The second predetermined liquid level can be approximately the same or slightly below the first predetermined liquid level and is the point at which the float valve is open. Note that transition between the open and closed position may be gradual as the liquid level varies between the first predetermined liquid level and second predetermined liquid level.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. An adapter for converting a bottled water dispenser to receive an upright liquid container, the adapter comprising:
a dispenser cover configured to cover a top opening of the bottled water dispenser and provide a surface to support the upright liquid container when placed thereon;
a siphon assembly having a suction portion for insertion into the upright liquid container and an output portion for discharging liquid into the top opening of the liquid container; and
a valve operatively coupled to the dispenser cover and configured to extend into the top opening of the bottled water dispenser, and further configured to accept the output portion of the siphon and regulate liquid discharge therefrom based on a liquid level within a reservoir chamber of the bottled water dispenser.

2. The adapter of claim 1, wherein the siphon assembly comprises an escutcheon coupled to the suction portion and configured to cover an opening at the top of the bottle and having a pressure relief disposed therein.

3. The adapter of claim 1, wherein the siphon assembly comprises an air bleed valve coupled to the output portion.

4. The adapter of claim 1, wherein the siphon assembly comprises a coupler configured to allow separation of the suction portion from the output portion.

5. The adapter of claim 1, wherein the coupler comprises a check valve configured to inhibit reverse flow of fluid through the output portion of the siphon assembly.

6. The adapter of claim 1, wherein the coupler comprises a check valve configured to inhibit fluid flow when the suction portion is separated from the output portion.

7. The adapter of claim 1, wherein the coupler comprises an air bleed valve.

8. The adapter of claim 1, wherein the dispenser cover comprises a first seal disposed within a bottom surface of the dispenser cover to isolate the top opening of the bottled water dispenser from an exterior environment.

9. The adapter of claim 1, wherein the dispenser cover comprises an upwardly extending lip disposed on a top surface of the dispenser cover.

10. The adapter of claim 1, wherein the dispenser cover comprises an anti-skid feature disposed on a top surface of the dispenser cover.

11. The adapter of claim 1, wherein the dispenser cover comprises:
a wedge extending from a bottom surface of the dispenser cover and having a shape configured to allow insertion into the top opening of the bottled water dispenser; and
a second seal disposed on an outer surface of the wedge configured to provide environmental isolation of the reservoir chamber from an exterior environment.

12. The adapter of claim 1, wherein the wedge has a frusto-conical shape and is springingly coupled to the cover to allow self-adjustment of the position of the second seal when the cover is placed onto the bottled water dispenser.

13. The adapter of claim 1, wherein the valve is a shutoff valve selected from the group of shutoff valves consisting of a float valve, a ball and float valve, a needle and seat valve, a level sensitive valve, and a ballcock.

14. The adapter of claim 1, further comprising a cage coupled to the cover and disposed around the valve.

15. The adapter of claim 1, wherein the siphon assembly comprises means for initiating siphon flow through the siphon assembly.

16. A system for dispensing liquid from an upright container, the system, comprising:
a dispenser body including a reservoir chamber disposed therein, a fluid receiving port in a top surface of the dispenser body in fluid communication with the reservoir chamber, and a tap in fluid communication with the reservoir and configured to controllably dispense the liquid from the reservoir;
a cover positioned on top of the dispenser body which covers the fluid receiving port;
a liquid container placed on top of the cover in an upright orientation;
means for siphoning liquid from the liquid container into the fluid receiving port; and
means for regulating flow of the siphoning means based on a liquid level within the reservoir chamber.

17. The system of claim 16, wherein the cover comprises:
a first seal positioned between a bottom surface of the cover and the top surface of the dispenser body to provide environmental isolation of the fluid receiving port from an exterior environment;
a wedge extending from a bottom surface of the cover into the fluid receiving port, having a side exterior profile generally conforming to an interior surface of the fluid receiving port;
a second seal positioned between the side exterior of the wedge and the interior surface of the fluid receiving port to provide environmental isolation of the reservoir chamber from the exterior environment.

18. The system of claim 17, wherein the wedge is springingly coupled to the cover to allow self-adjustment of the position of the second seal relative to the interior surface of the fluid receiving port.

19. A method for transferring liquid from an upright container into a bottled water dispenser of the type having an internal reservoir and a top opening for receiving an inverted water bottle to supply fluid to the reservoir, the method comprising:
covering the top opening of the bottled water dispenser with a cover assembly;
placing a liquid container in an upright orientation on top of the cover assembly;
siphoning liquid from the liquid container into the reservoir via a siphon assembly;
interrupting liquid flow through the siphon assembly when a first predetermined liquid level is reached within the reservoir; and
reestablishing liquid flow through the siphon assembly when a second predetermined liquid level is reached within the reservoir.

20. The method of claim 19, wherein covering the top opening of the bottled water dispenser comprises sealing the top opening of the bottled water dispenser.
